(19) United States
(12) Patent Application Publication
(10) Pub. No.: US 2026/0181680 A1
(43) Pub. Date: Jun. 25, 2026

(54) AMBIENT INTERNET OF THINGS (AIOT) GRANT PROCESSING AND MESSAGE PRIORITIZATION BY AN AIOT READER

(71) Applicant: InterDigital Patent Holdings, Inc., Wilmington, DE (US)

(72) Inventors: Martino Freda, Laval (CA); Jongwoo Hong, New York, NY (US); Paul Marinier, Brossard (CA); Aata El Hamss, Laval (CA); Erdem Bala, East Meadow, NY (US); Kevin Wanuga, Souderton, PA (US); Remun Koirala, London (GB)

(73) Assignee: InterDigital Patent Holdings, Inc., Wilmington, DE (US)

(21) Appl. No.: 18/990,349

(22) Filed: Dec. 20, 2024

(51) Int. Cl. H04W 72/51

(52) U.S. Cl. CPC H04W 72/51

(57) ABSTRACT

Methods, systems, and apparatuses for ambient internet of things (AIOT) grant processing are provided. A reader wireless transmit/receive unit (WTRU) may be configured and/or preconfigured with one or more transmission conditions. The reader WTRU may receive a set of configured grants for transmitting at least one of: a paging message or an access start message to a first set of AIOT devices using the set of configured resources. The reader WTRU receives a set of first transmissions from the first set of AIOT devices using the set of configured resources. The WTRU receives, from the base station, a dynamic grant indicative of a set of dynamic resources. The WTRU evaluates the set of first transmissions based on the one or more transmission conditions. The reader WTRU initiates a set of second transmissions associated with a sub-set of AIOT devices in the set of dynamic resources based on the evaluation.

### BACKGROUND

In 3GPP, a study item regarding ambient internet of things (AIOT) has emerged from an increased popularity of IOT. In recent years, AIOT has attracted attention in wireless communication world. More things are expected to be interconnected for improving productivity, efficiency and increasing comforts of life. Further reduction of size, complexity, and power consumption of AIOT devices can enable deployment of tens or even hundreds of billion AIOT devices for various applications and provide added value across entire value chain. It is impossible to power all the IOT devices by battery that needs to be replaced or recharged manually, which leads to high maintenance cost, serious environmental issues, and even safety hazards for some use cases (e.g., wireless sensors in electric power and petroleum industry).

Considering the limited size and complexity required by practical applications for battery-less AIOT devices with no energy storage capability or the AIOT devices with limited energy storage that do not need to be replaced or recharged manually, an output power of an energy harvester is typically from 1 μW to a few hundreds of μW. Existing cellular devices may not work well with energy harvesting due to their peak power consumption of higher than 10 mW.

### SUMMARY

In one or more embodiments, a wireless transmit/receive unit (WTRU) comprising a memory, a transceiver, and a processor is provided. The transceiver and the processor are configured to receive, from a base station, configuration information indicative of a set of transmission conditions and a set of configured resources. The transceiver and the processor are configured to transmit at least one of: a paging message or an access start message to a first set of ambient internet-of-things (AIOT) devices using the set of configured resources. The transceiver and the processor are configured to receive a set of first transmissions from the first set of AIOT devices using the set of configured resources. The transceiver and the processor are configured to receive, from the base station, a dynamic grant indicative of a set of dynamic resources. The transceiver and the processor are configured to evaluate the set of first transmissions based on the set of transmission conditions. The transceiver and the processor are configured to select a sub-set of AIOT devices based on the evaluation. The transceiver and the processor are configured to initiate a set of second transmissions associated with the sub-set of AIOT devices in the set of dynamic resources.

In an embodiment, evaluating the set of first transmissions includes determining that the set of dynamic resources is less than a required set of resources associated with the first set of AIOT devices.

In an embodiment, the WTRU receives, from the base station, an indication of a set of AIOT resources and a set of AIOT commands associated with a second set of AIOT devices from the first set of AIOT devices. The WTRU transmits the one or more AIOT commands from the set of AIOT commands to the second set of AIOT devices using one or more AIOT resources from the set of AIOT resources.

In an embodiment, the WTRU determines one or more available dynamic resources from the set of dynamic resources after initiating the set of second transmissions. The WTRU determines that the one or more available dynamic resources are greater than a required set of resources associated with a third set of AIOT devices from the first set of AIOT devices. The WTRU initiates the set of second transmissions associated with the third set of AIOT devices using the one or more available dynamic resources.

In an embodiment, the set of transmission conditions includes one or more of: a signal strength threshold, or a retransmission threshold.

In an embodiment, evaluating the set of first transmissions includes determining a received signal strength of a sub-set of transmissions of the first set of transmissions associated with the sub-set of AIOT devices.

In an embodiment, selecting the sub-set of AIOT devices includes selecting the sub-set of AIOT devices upon determining that the received signal strength exceeds the signal strength threshold.

In an embodiment, evaluating the set of first transmissions includes determining a number of retransmissions associated with the sub-set of AIOT devices.

In an embodiment, selecting the sub-set of AIOT devices includes selecting the sub-set of AIOT devices upon determining that the number of retransmissions is less than the retransmission threshold.

In an embodiment, the set of second transmissions includes at least one AIOT command of the set of AIOT commands.

In an embodiment, the set of first transmissions includes at least one first message and the set of second transmissions includes at least one second message.

In one or more embodiments, a method for use in a WTRU is provided. The method includes receiving, from a base station, configuration information indicative of a set of transmission conditions and a set of configured resources. The method includes transmitting at least one of: a paging message or an access start message to a first set of AIOT devices using the set of configured resources. The method includes receiving a set of first transmissions from the first set of AIOT devices using the set of configured resources. The method includes receiving, from the base station, a dynamic grant indicative of a set of dynamic resources. The method includes evaluating the set of first transmissions based on the set of transmission conditions. The method includes selecting a sub-set of AIOT devices based on the evaluation. The method includes initiating a set of second transmissions associated with the sub-set of AIOT devices in the set of dynamic resources.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example inventory procedure for a radio frequency identification device (RFID) according to one or more embodiments;

FIG. 3 illustrates an example random access procedure for an ambient internet of things (AIOT) device according to one or more embodiments;

FIG. 4 illustrates an example first topology between a base station and an AIOT device according to one or more embodiments;

FIG. 5 illustrates an example second topology between a base station, an AIOT device, and an intermediate node according to one or more embodiments;

FIG. 6A illustrates an example third topology between a base station, an assisting node, and an AIOT device with downlink assistance according to one or more embodiments;

FIG. 6B illustrates an example third topology between a base station, an assisting node, and an AIOT device with uplink assistance according to one or more embodiments;

FIG. 7 illustrates an example fourth topology between a WTRU and an AIOT device according to one or more embodiments;

FIG. 8 illustrates an example message transmission procedure according to one or more embodiments; and

FIG. 9 is a flowchart illustrating a method for AIOT grant processing according to one or more embodiments.

### DETAILED DESCRIPTION

As discussed herein, one or more abbreviations in the following (non-exhaustive) list, shown in Table 1, may be used herein.

TABLE 1

| | |
|---|---|
| ACK | Acknowledgement |
| BLER | Block Error Rate |
| BWP | Bandwidth Part |
| CA | Carrier aggregation |
| CAP | Channel Access Priority |
| CAPC | Channel access priority class |
| CCA | Clear Channel Assessment |
| CCE | Control Channel Element |
| CE | Control Element |
| CG | Configured grant or cell group |
| CHO | Conditional handover |
| CP | Cyclic Prefix |
| CP-OFDM | Conventional OFDM (relying on cyclic prefix) |
| CPA | Conditional PsCell addition |
| CPAC | Conditional PsCell addition/change |
| CPC | Conditional PsCell change |
| CQI | Channel Quality Indicator |
| CRC | Cyclic Redundancy Check |
| CSI | Channel State Information |
| CWS | Contention Window Size |
| CO | Channel Occupancy |
| DAI | Downlink Assignment Index |
| DC | Dual connectivity |
| DCI | Downlink Control Information |
| DFI | Downlink feedback information |
| DG | Dynamic grant |
| DL | Downlink |
| DM-RS | Demodulation Reference Signal |
| DO-DTT | Device Originated Device Terminated Triggered |
| DRB | Data Radio Bearer |
| eLAA | enhanced Licensed Assisted Access |
| EPC | Electronic product code |
| FeLAA | Further enhanced Licensed Assisted Access |
| HARQ | Hybrid Automatic Repeat Request |
| IS | In sync |
| LAA | License Assisted Access |
| LBT | Listen-Before-Talk |
| LTE | Long Term Evolution e.g. from 3GPP LTE R8 and up |
| LTM | L1/2 triggered mobility |
| NACK | Negative ACK |
| MCG | Master cell group |
| MAC | Medium access control |
| MCS | Modulation and Coding Scheme |
| MIMO | Multiple Input Multiple Output |
| NR | New Radio |
| OFDM | Orthogonal Frequency-Division Multiplexing |
| OOS | Out of sync |
| PCell | Primary cell |
| PCI | Physical cell identity |
| PHY | Physical Layer |
| PID | Process ID |
| PO | Paging Occasion |
| PRACH | Physical Random Access Channel |
| PSCell | Primary SCG Cell |
| PSS | Primary Synchronization Signal |
| RA | Random Access (or procedure) |
| RACH | Random Access Channel |
| RAR | Random Access Response |
| RCU | Radio access network Central Unit |
| RF | Radio Front end |
| RLC | Radio Link Control |
| RLF | Radio Link Failure |
| RLM | Radio Link Monitoring |
| RNTI | Radio Network Identifier |
| RO | RACH occasion |
| RRC | Radio Resource Control |
| RRM | Radio Resource Management |
| RS | Reference Signal |
| RSRP | Reference Signal Received Power |
| RSSI | Received Signal Strength Indicator |
| SCell | Secondary cell |
| SCG | Secondary cell group |
| SDU | Service Data Unit |
| SIB | System Information Broadcast |
| SpCell | Special Cell* |
| SRS | Sounding Reference Signal |
| SS | Synchronization Signal |
| SSS | Secondary Synchronization Signal |
| SWG | Switching Gap (in a self-contained subframe) |
| SPS | Semi-persistent scheduling |
| SUL | Supplemental Uplink |
| TB | Transport Block |
| TBS | Transport Block Size |
| TRP | Transmission/Reception Point |
| TSC | Time-sensitive communications |
| TSN | Time-sensitive networking |
| TTT | Time to trigger |
| UAV | Uncrewed Aerial Vehicle |
| UL | Uplink |
| URLLC | Ultra-Reliable and Low Latency Communications |
| WBWP | Wide Bandwidth Part |
| WLAN | Wireless Local Area Networks and related technologies |
| | (IEEE 802.xx domain) |
| XPC | Extended Protocol Control |

In an example, the term SpCell may either refer to a PCell of a master cell group (MCG) or a PSCell of a secondary cell group (SCG) depending on whether a media access control (MAC) entity is associated to the MCG or the SCG.

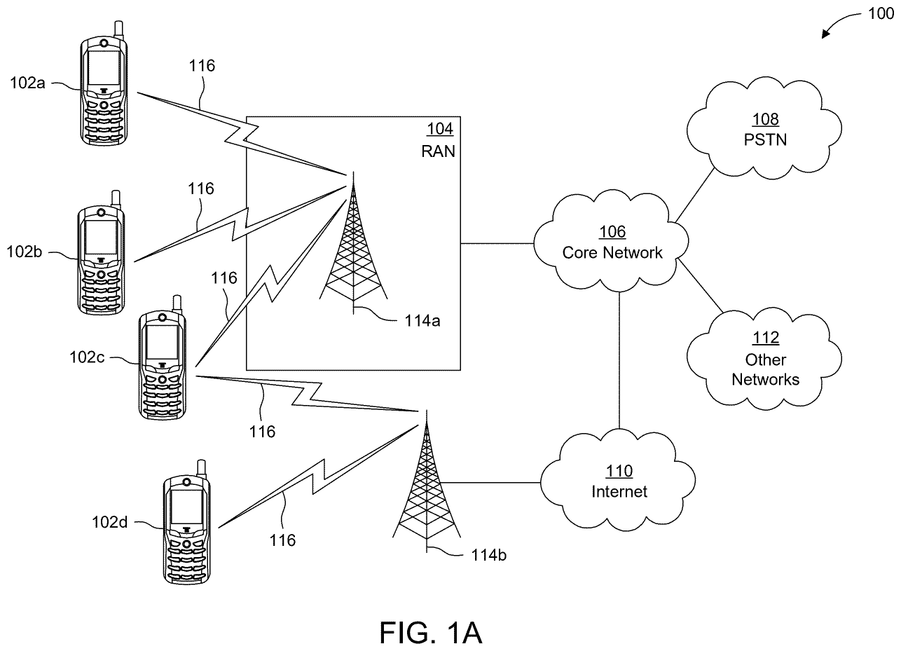

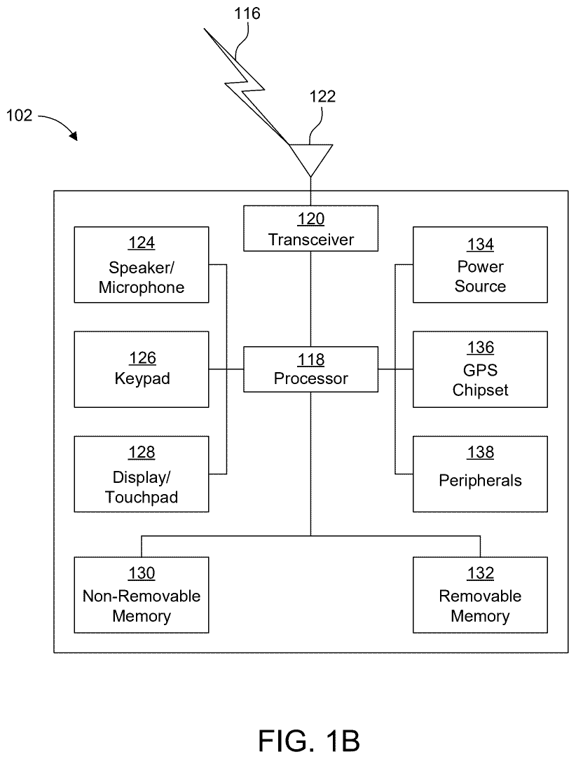

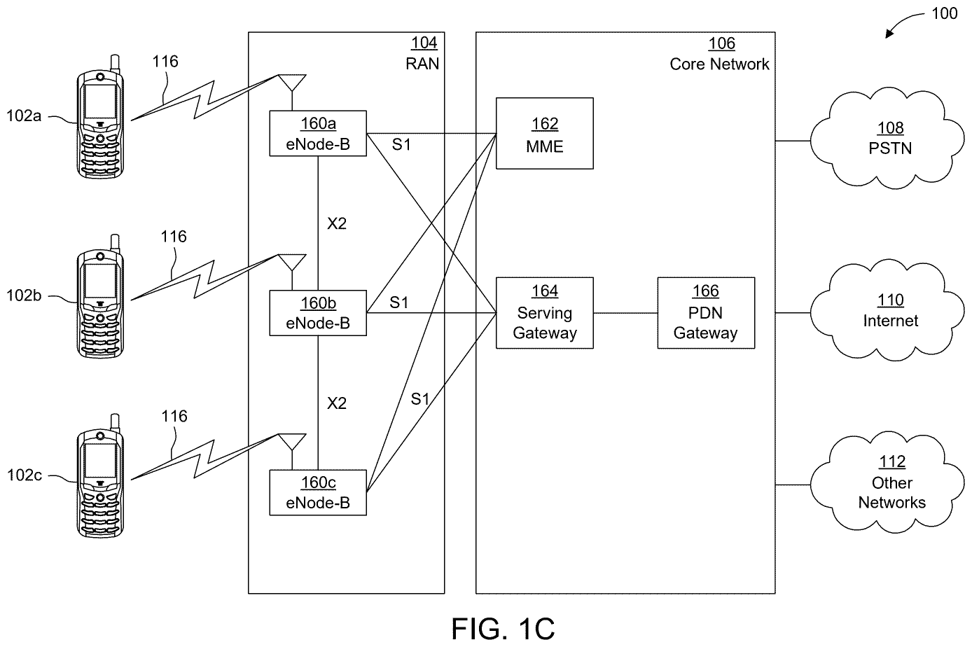

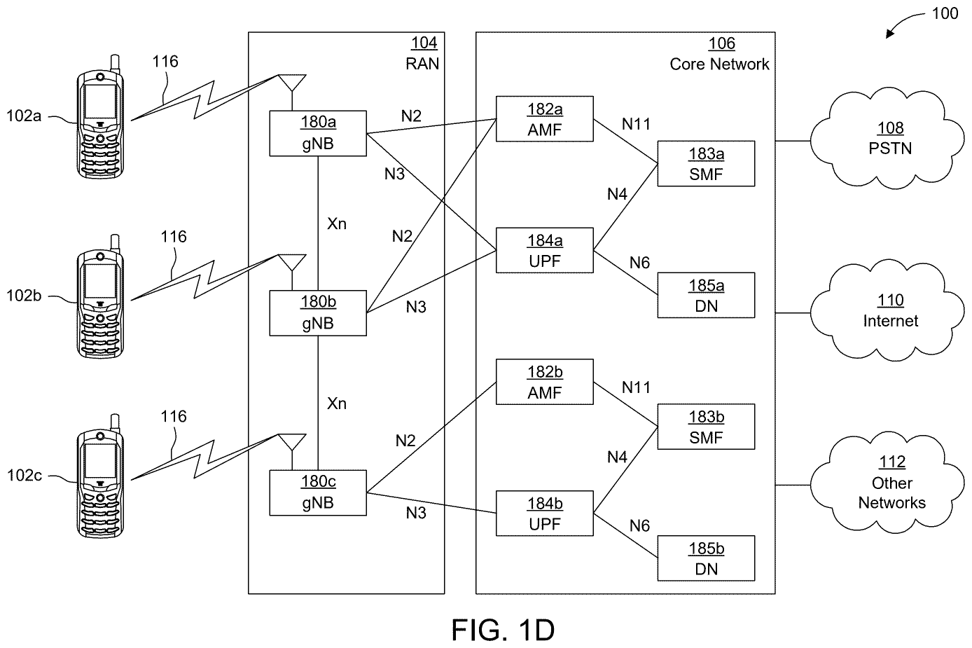

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

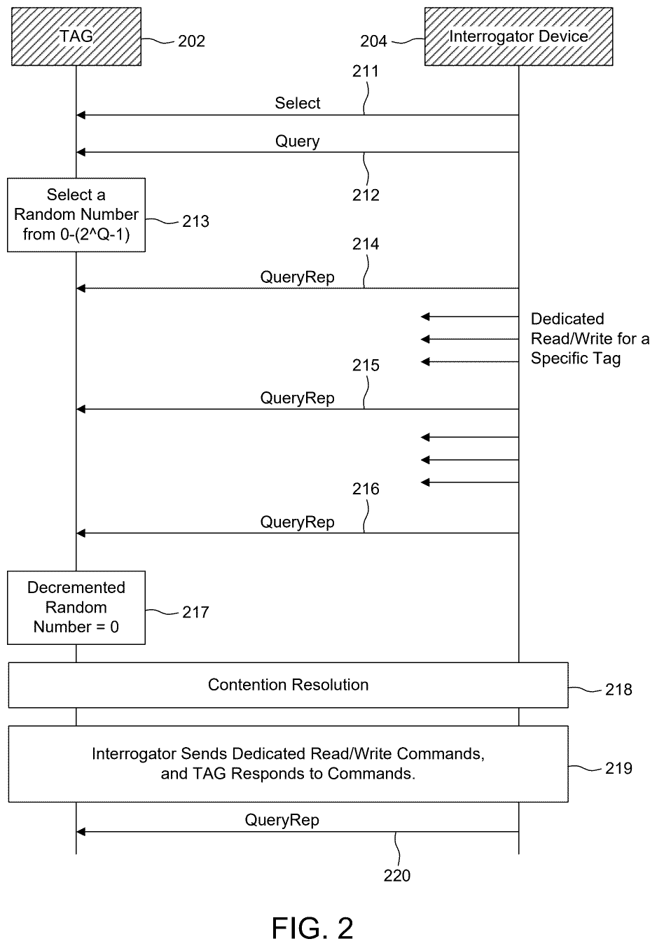

Referring now to FIG. 2, an example inventory procedure for a radio frequency identification device (RFID) is shown according to one or more embodiments. The inventory procedure may be performed between a tag 202 and an interrogator device 204. In an example, the tag 202 is an RFID tag and the interrogator device is an RFID reader device. RFID is usually used currently for applications of asset identification.

In the inventory procedure, at 211, the interrogator device 204 transmits a select message to one or more RFID tags. At 212, the interrogator device 204 transmits a query message to energize all or a subset of tags including the tag 202. Following the query message, the tag 202 selects a random number from 0-2\hat{ }Q−1 and loads a counter in a memory of the tag 202 with that number. At 214-216, at each transmission of one or more query repetition messages, the tag 202 decrements the counter until the counter reaches 0. At 217, when the counter reaches 0, the tag 202 initiates a contention resolution procedure at 218. The contention resolution procedure includes transmitting a device identifier (ID) in an uplink transmission, and waiting for a confirmation of the device ID in a downlink transmission (e.g., to address a possible collision between multiple devices selecting a same random number). For a device such as the tag 202 that has passed contention resolution, the interrogator device 204 may transmit multiple read/write commands at 219, to which the tag 202 may respond. At 220, the interrogator device 204 may continue the transmission of the one or more query repetition messages to the tag 202.

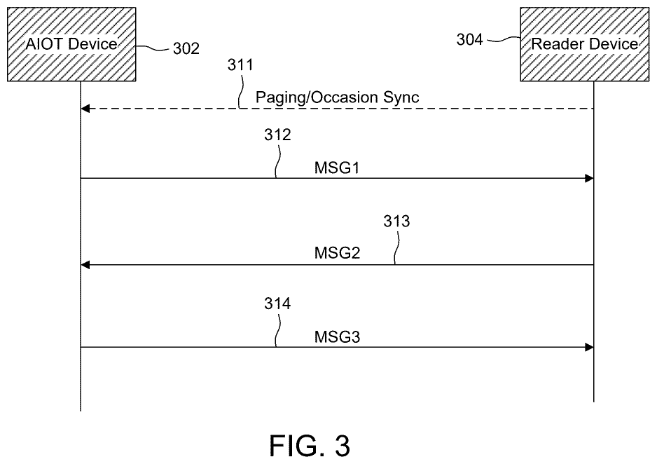

Referring now to FIG. 3, an example random access procedure for an AIOT device is shown according to one or more embodiments. The inventory procedure may be performed between an AIOT device 302 and a reader device 304. At 311, the reader device 304 may transmit a paging message and/or an occasion synchronization message. At 312, the AIOT device 302 may transmit a first message (i.e. MSG1) to the reader device 304. In the first message, the AIOT device 302 may transmit a random ID. At 313, the reader device 304 may transmit a second message to the AIOT device 302. In the second message, the reader device 304 may respond (e.g., echo back) to the random ID. At 314, the AIOT device 302 may transmit a third message to the reader device 304. In the third message, the AIOT device 302 may transmit a device ID and/or application layer data to the reader device 304.

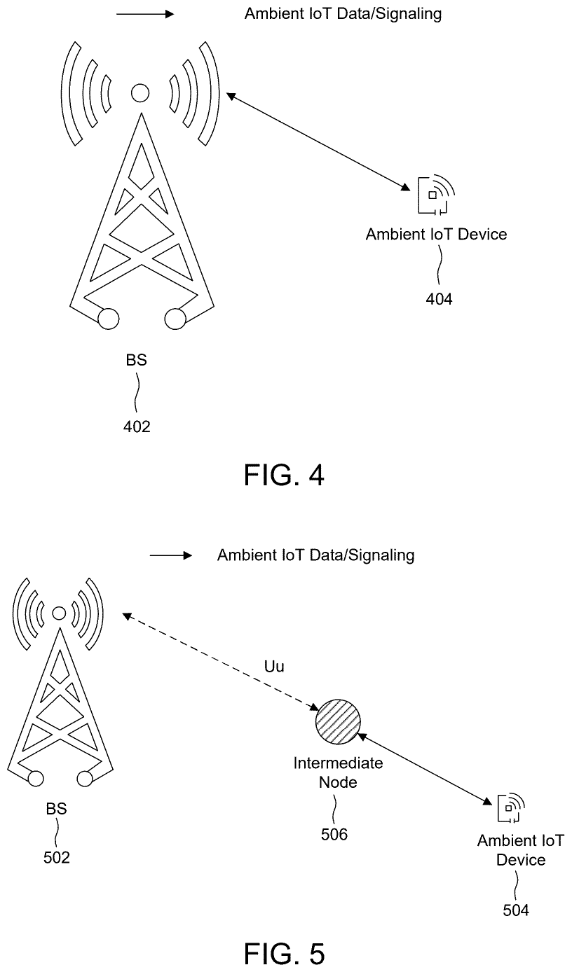

Referring now to FIG. 4, an example first topology between a base station 402 and an AIOT device 404 is shown according to one or more embodiments. In the first topology, the AIOT device 404 directly and bidirectionally communicates with the base station 402. The communication between the base station 402 and the AIOT device 404 includes AIOT data and/or signaling. This topology includes a possibility that the base station transmitting to the AIOT device 404 may be different from the base station receiving from the AIOT device 404.

Referring now to FIG. 5, an example second topology between a base station 502, an AIOT device 504, and an intermediate node 506 is shown according to one or more embodiments. In the second topology, the AIOT device 504 communicates bidirectionally with the intermediate node 506 between the AIOT device 504 and the base station 502. In this topology, the intermediate node 506 may be a relay, an IAB node, a WTRU, and/or a repeater, etc. which may be capable of AIOT. The intermediate node 506 may transfer the information between the base station 502 and the AIOT device 504.

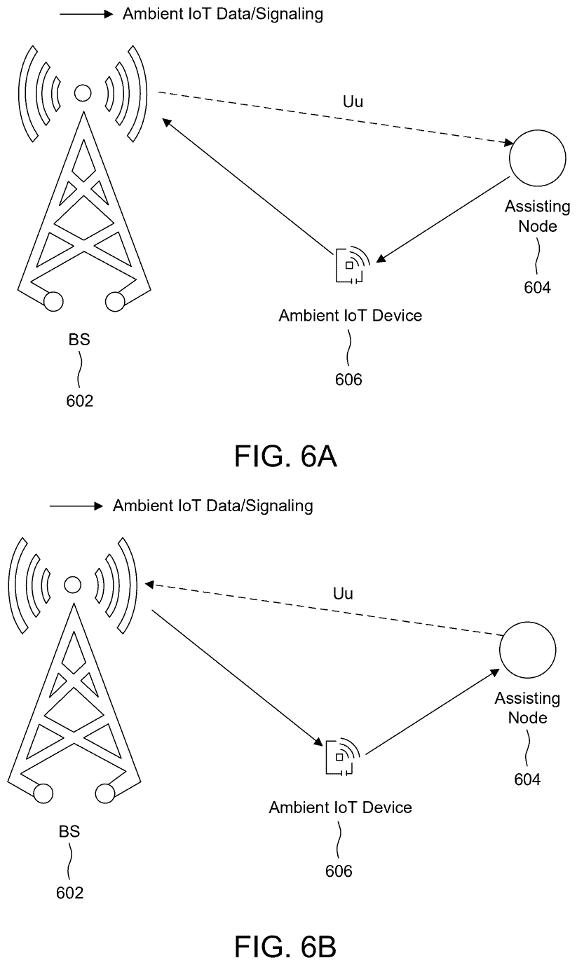

Referring now to FIG. 6A, an example third topology between a base station 602, an assisting node 604, and an AIOT device 606 with downlink assistance is shown according to one or more embodiments.

Referring now to FIG. 6B, an example third topology between a base station 602, an assisting node 604, and an AIOT device 606 with uplink assistance is shown according to one or more embodiments.

In the third topology, the AIOT device 606 transmits data/signaling to the base station 602, and receives data and/or signaling from the assisting node 604 as shown in FIG. 6A; or the AIOT device 606 receives data and/or signaling from the base station 602 and transmits data and/or signaling to the assisting node 604 as shown in FIG. 6B. In this topology, the assisting node may be the relay, the IAB, the WTRU, and/or the repeater, etc. which is capable of AIOT.

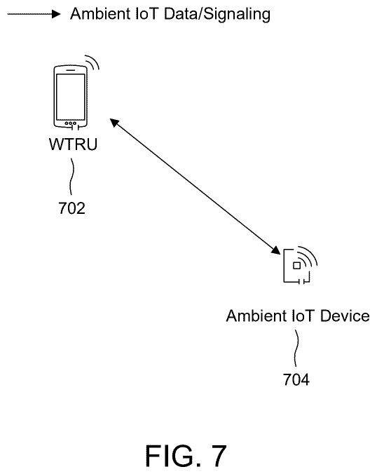

Referring now to FIG. 7, an example fourth topology between a WTRU 702 and an AIOT device 704 is shown according to one or more embodiments. In the fourth topology, the AIOT device 704 communicates bidirectionally with the WTRU 702. The communication between the WTRU 702 and the AIOT device 704 includes the AIOT data and/or signaling.

In the second topology, the WTRU (i.e. the WTRU functioning as the reader device) receives one or more resources for AIOT transmission (to one or more AIOT devices) and reception (from one or more AIOT devices). When the WTRU is in RRC_CONNECTED mode, the base station (e.g., the gNB) may schedule the one or more AIOT resources dynamically and/or by configured grant, much like in Uu and/or in sidelink etc.

The sidelink and/or Uu scheduling may use a mechanism of BSR reporting combined with grant processing that uses logical channel prioritization (LCP). The WTRU in each case may report the data available for transmission to the network and the network may provide UL and/or SL grants in return. The WTRU is then configured with one or more rules on how to include the data available for transmission in each grant. Specifically, the WTRU includes the data in the grant based on a priority and up to a function of a logical channel bit rate.

In the second topology, the WTRU may operate in RRC_CONNECTED mode while obtaining the one or more resources for the AIOT operation from the network. As a result, a similar approach is used for this case whereby the WTRU reports the information about its resource needs (and/or buffer status etc.) to the network in a BSR-like transmission and receives the resource grant from the network.

In the second topology, re-using the Uu and/or the SL LCP procedure would not be feasible for the AIOT however, there is no notion of logical channels in the AIOT. Specifically, it has been agreed that logical channels are not supported by AIOT media access control (MAC). Because the network allocates the one or more resources for both, the reader device's transmissions and the AIOT device's response transmissions, the reader needs to account for the AIOT device transmissions when choosing the data (e.g., an amount of the data) to transmit in the grant provided by the network. Unlike Uu or SL, where a receiving entity is the network or a peer WTRU, the receiving entity of the reader's transmissions is the AIOT device. Such AIOT devices, because of their nature, have a number of restrictions, for example, the AIOT devices are assumed to operate under specific time restrictions with respect to their transmissions/receptions. In an example, there is a minimum and maximum time between a specific R2D and corresponding D2R (or between a D2R and corresponding R2D) to ensure the AIOT device operates correctly. In an example, following the MSG1 transmission by the AIOT device, the corresponding MSG2 transmission should be received by a maximum time. In an example, multiple transmissions intended to the same AIOT device must be spaced by at least a predefined time. Therefore, there is a need for a technique to schedule pending transmissions and/or receptions at the WTRU (e.g. the reader device or a reader WTRU) within an AIOT resource grant provided by the network in order to meet one or more of the aforementioned AIOT device requirements.

In various embodiments of the present disclosure, a technique for scheduling the pending transmissions and/or receptions at the WTRU is provided. The reader WTRU determines a number of the MSG2 transmissions and/or the command transmissions and corresponding recipient AIOT devices of those transmissions to include in a network provided AIOT resource grant based on a grant size, one or more MSG1 transmission properties and a timing of the MSG1 reception compared to the grant.

For configuration and initial resource reception for inventory, the WTRU receives e.g., in the RRC signaling) a configured first transmission (e.g., the MSG1) property condition. In an example, the condition may be associated with a threshold first-transmission received signal strength (e.g., the RSRP), a threshold number of first transmissions and/or retransmissions by an AIOT device, and/or one or more conditions to prioritize a re-access etc. The WTRU receives (e.g., in the RRC signaling) a set of semi-static resources (e.g., CG) for initiation of an inventory and/or command procedure. The WTRU transmits, in one or more semi-static resources, an AIOT paging message and multiple access occasion start messages. The WTRU receives, in one or more semi-static resources, one or more first transmissions from a first set of AIOT devices performing AIOT random access. The WTRU receives, from the network (e.g., in the RRC signaling), one or more AIOT command messages (i.e., upper layer data) to be transmitted to a second set of AIOT devices, along with a required amount of AIOT resources to be used for one or more AIOT command response transmissions by one or more AIOT devices of the second set of AIOT devices. In an example, the second set of AIOT devices may be the same as the first set of AIOT devices.

For reception of a dynamic grant, the WTRU receives (e.g., in the DCI) an AIOT-link grant (e.g. during an inventory operation). In an example, the AIOT-link grant may be e.g., multiple consecutive Uu slots and/or RBs usable for AIOT transmission by the WTRU and/or devices.

The WTRU (e.g., the reader WTRU and/or the reader device) transmits and/or receives using the one or more AIOT resources. If the grant is large enough to include all second transmissions (i.e., the MSG2) to all the AIOT devices in the first set of AIOT devices (and corresponding third transmissions (e.g., the MSG3) by each device in the first set of AIOT devices) and the AIOT command transmissions to the AIOT devices in the second set of AIOT devices, the WTRU may include, in the grant, a second transmission for each AIOT device in the first set of AIOT devices, resources for transmission of third transmission by each of the devices in the first set of AIOT devices, one or more received AIOT command messages, and resources for AIOT command response by one or more AIOT devices of the second set of AIOT devices.

If the grant is large enough to include all second transmissions (i.e., the MSG2) to all the AIOT devices in the first set of AIOT devices (and corresponding third transmissions (e.g., the MSG3) by each device in the first set of AIOT devices) and the AIOT command transmissions to the AIOT devices in the second set of AIOT devices, the WTRU may include, in the grant, only the second transmissions to a third set of AIOT devices (where the third set of AIOT devices is a subset of the first set of AIOT devices) for which the first transmission property condition is met. In an example, the condition may be that a first-transmission RSRP is above a threshold. In an example, the WTRU may include all re-access responses to the AIOT devices for which the one or more re-access conditions are met.

If the grant is large enough to include all second transmissions (i.e., the MSG2) to all the AIOT devices in the first set of AIOT devices (and corresponding third transmissions (e.g., the MSG3) by each AIOT device in the first set of AIOT devices) and the AIOT command transmissions to the AIOT devices in the second set of AIOT devices, the WTRU may include, in the grant, the one or more AIOT command messages to a fourth set of AIOT devices (where the fourth set of AIOT devices is a subset of the second set of AIOT devices). In an example, the fourth set of AIOT devices may be determined such that there are sufficient resources in the grant for the AIOT command message transmission and command response for all the AIOT devices in the fourth set of AIOT devices.

If the one or more resources are still available in the grant, the WTRU may include any additional second transmissions and/or command transmissions based on the timing of the first transmission reception associated with the one or more AIOT device (i.e., for the AIOT devices not in the third or fourth set of AIOT devices) (e.g., select the second transmission and/or command transmission with the largest time since reception, by the WTRU, of the first transmission from the AIOT device).

The WTRU may transmit the one or more messages (second transmission, command) using the grant.

In the present disclosure, the terms device, AIOT device, AIOT WTRU, and tag may be used interchangeably to mean the AIOT device that is being inventoried and/or queried by the reader device. The term reader (e.g. the reader device) may refer to an entity which queries the AIOT device, either directly, or via an intermediate WTRU in the second topology.

The term reader (e.g. the reader device) in the second topology may also refer to the intermediate WTRU (e.g. an intermediate UE). As a result, the term reader (e.g. the reader device) may refer to a network node or a WTRU, depending on the context and/or the topology. In the present disclosure, the terms reader, network, intermediate WTRU, and WTRU may be used interchangeably to mean the reader (e.g. the reader device).

In the present disclosure, the inventory may refer to an overall procedure of a reader device triggering access by multiple AIOT devices using a sequence of messages (e.g., similar to query, followed by query rep in RFID). Specifically, the inventory procedure may refer to a single round of attempts to have each AIOT device respond and/or attempt to respond with its access ID and/or perform a RACH procedure. Specifically, the inventory procedure may refer to a set of access occasions which may have 0 or at least 1 device respond within the access occasion. The inventory procedure may occur similar to legacy RFID procedure. Although referred to herein as inventory procedure, it may be termed differently in device requirements and/or specifications (e.g., query procedure, paging procedure, etc.).

In the present disclosure, the command may refer to an overall command procedure which may be triggered by a WTRU (e.g., the reader) for one or more AIOT devices after the inventory procedure is completed (e.g., a RACH procedure and a paging and/or a query procedure etc.). In an example, the WTRU may trigger the command procedure for one or more WTRUs after the inventory procedure. In an example, the WTRU may perform data communication with the one or more AIOT devices via an AIOT interface during a command procedure. In an example, the WTRU may transmit a command with an operation request (e.g., read, write etc.) with one or more devices. In an example, a read command is that a WTRU allows to read (e.g., all, a part of, and/or a portion of etc.) device information (e.g., a memory, an EPC memory, and/or a TID memory, etc.). In an example, a write command is that the reader allows to write a word and/or information in a device's memory (e.g., the memory, the EPC memory, and/or the TID memory etc.).

In the present disclosure, an occasion refers to an opportunity for the AIOT device transmission that may be delimited by the transmission of a query repetition (i.e. query rep) message (or similar messages etc.). An AIOT device may perform the transmission in the occasion by performing the AIOT transmission in a defined time following the query rep message associated with that transmission. In an example, the occasion may include both a time aspect and a frequency aspect. An AIOT device may determine the occasion as a transmission following a specific query rep message, and by transmitting on one of a number of frequencies (e.g., the FDM). Wherever implementations indicate selection of an occasion, they can apply equivalently to selection of only a time component and/or selection of a frequency component.

An AIOT transaction herein may include one or more of: an inventory procedure, and an inventory and command procedure, a command procedure, and/or a random access procedure, in the context of AIOT.

Herein, depending on the implementation or description, any reference to time can be associated with an absolute time measurement (e.g., seconds, slots, and/or frames, etc.). In an example, any reference to time can refer to a number of executions of a procedure, possibly triggered by the reader (e.g., number of inventory procedures, number of accesses or RACH procedures, etc.). In an example, any reference to time can refer to a number of messages, possibly of a specific type, and/or containing specific information, as described herein, received or transmitted.

A configuration and/or a pre-configuration may refer to any configuration received by a message (e.g., an RRC message, a MAC CE, a PHY layer signal, a data PDU, and/or a control PDU associated with any or a new protocol layer, etc.) received from either a network node, or from another AIOT device and/or a WTRU.

A device herein may be configured by the reader, whereby the reader may be a network node and/or a WTRU (e.g., the intermediate WTRU in the second topology). In the case of a WTRU, the WTRU may derive the device configuration itself, or receive the device configuration from the network, in which case, the device configuration is relayed from the network to the device by the WTRU. In an example, a WTRU configuration (in the case of a WTRU in the second topology) may be received from a network node (e.g., the gNB).

The AIOT grant may refer to one or more time and/or frequency resources (e.g., a slot, multiple slots, a CG resource, a set of CG occasions associated with a specific timer, period of time, and/or procedure, etc.) allocated by the network, possibly using a single message (e.g., a DCI message and/or an RRC message etc.). In an example, the grant may include the set of all resources that are allocated by the network using a single DCI message, and/or may include the set of all resources that are allocated by the network using an RRC configuration (e.g., all resources of a configured grant-like resource), possibly within a configured and/or determined time window.

The AIOT grant may refer to a set of time and/or frequency consecutive resources, possibly allocated by the network. In an example, the AIOT grant may refer to a set of consecutive symbols and/or slots that can be used by the reader for the AIOT transmissions and/or allocated by the reader to devices for one or more device AIOT transmissions.

The AIOT grant may refer to a specific instance of a particular resource allocated by the network. In an example, the set of resources allocated by the network may be further subdivided into configured or predefined resource instances either in terms of configuration and/or specification. In an example, this may include a specific instance of a configured grant resource. In an example, this may include a set of resources allowing transmission and/or reception of one or more defined AIOT messages.

The AIOT grant may refer to a set of related and/or associated resources. In an example, this may include a set of associated resources, where the association may be configured by the network and/or determined by the reader WTRU, where the association may include the set of resources required to perform an R2D transmission and receive the corresponding D2R responses, or vice versa. In an example, a grant herein may refer to the set of resources determined by the reader to perform the MSG2 transmission along with the resources allocated and/or associated (e.g., within the MSG2 transmission itself) with the corresponding MSG3 transmissions by each of the AIOT devices identified in the MSG2.

The reader may be configured and/or preconfigured with one or more restrictions and/or transmission conditions for the transmission on the grant. In an example, the reader may be provided with the AIOT grant and may be configured with one or more restrictions related to the transmissions which can be performed on the AIOT grant. The reader may be allowed to transmit one or more AIOT messages on a specific grant, but may not be allowed to transmit other messages on that grant. In an example, the grant may be specific to the transmission associated with one or more factors, for example, a restriction may be associated with a specific AIOT grant. The reader may apply the restriction on all of the resources associated with the AIOT grant. In an example, the restriction may be associated with a single transmission by the reader within the AIOT grant, possibly of multiple transmissions which can be performed in the grant. In an example, the reader may transmit multiple random IDs in a single MSG2 transmission, and the restriction may be applied to one or more IDs (and/or the one or more AIOT devices represented by the one or more IDs) included in the MSG2 transmission.

In an example, the restrictions may be on any of the following factors associated with the transmission, for example, the restrictions may be associated with AIOT message type. In an example, the restrictions may be related to the specific AIOT message and/or message type that is allowed to be transmitted by an AIOT device on an AIOT grant. The message type may refer to the specific message associated with an AIOT procedure, such as but not limited to the MSG2, the command message, the acknowledgement message, the paging message, the sync message, the read command message versus the write command message, and/or the command message requiring a device response versus the command message not requiring a device response, etc. The message type may refer to one or more specific contents of the message, such as but not limited to whether a particular message includes or does not include a resource allocation, a control element indicating specific behavior for the one or more AIOT devices, etc. In an example, the reader may be allowed to transmit an AIOT message of a first type in the AIOT grant, but not of a second type.

In an example, the restrictions may be associated with one or more intended devices. In an example, the restriction may be related to the one or more intended devices of the transmission, such as but not limited to the one or more specific AIOT devices to which the reader is transmitting. In an example, the restriction may be related to whether the transmission is intended for a single AIOT device or to multiple AIOT devices and/or all AIOT devices. In an example, the restriction may be related to one or more capabilities of the one or more AIOT devices that are intended recipients of the transmission.

In an example, the restrictions may be associated with the message size, length, and/or duration etc.

In an example, the restrictions may be related to the size of the transmission by the reader and/or the expected size of the one or more corresponding responses by the AIOT devices, where such message size may be measured in terms of a number of information bits, transmission length and/or duration (e.g. in time), a number or amount of resources used and/or allocated for the message (e.g., in terms of slots, symbols, time and/or frequency resource quantity, etc.). In an example, a resource may be used only for transmissions of a specific size, within a size range, smaller than a threshold size, larger than a threshold size, etc.

In an example, the reader may determine whether to apply the restriction on a grant based on one or more of the following:

The one or more restrictions may be based on implicit and/or explicit network signaling. In an example, the reader WTRU may receive the restriction on one or more of the factors using explicit signaling. In an example, the network may indicate such in the DCI, the MAC CE, and/or the RRC message, etc. that allocates the AIOT grant, and/or may provide such configuration separately (e.g., in the RRC message indicating which resource should be tied to which factor). In an example, the WTRU may receive a message and/or configuration from the network which ties a timing aspect to a specific factor. In an example, a slot number, a frame number, and/or the relationship between resources in different slot numbers, etc. may be configured in the RRC message to be associated with a specific factor. In an example, a WTRU may receive the AIOT grant (e.g., in the DCI) which indicates that the resource is usable only for transmission of the MSG2. In an example, a WTRU may receive a grant (e.g., in the DCI) which indicates that the resource can be used for either the MSG2 or the command. In an example, a WTRU may receive the AIOT grant (e.g., in the DCI) which indicates that the grant should be used for command transmission to a specific device. In an example, the DCI, the MAC CE, and/or the RRC message which provides the grant to the WTRU may indicate the device ID (e.g., random ID in the MSG1, the AS ID, and/or other etc.). In an example, the WTRU may receive the AIOT grant which indicates that the AIOT grant can be used for one or more command messages for which the expected response has less than a threshold number of bits, has between a first number of bits and a second number of bits, etc. In an example, a WTRU may receive the AIOT grant which indicates that the AIOT grant can be used for the one or more command messages which do not require a response by the AIOT device.

The reader may determine the restrictions implicitly from network signaling. The reader may be configured and/or preconfigured with the one or more rules which may associate a property of the AIOT grant to the one or more factors associated with the transmission on the AIOT grant. In an example, the factor may be associated with whether the grant is semi-static or dynamic. In an example, the WTRU may use one or more semi-static grants for transmission of paging and/or occasion start messages, and may use dynamic grants for the one or more command messages.

The one or more factors may be associated with the size of the grant. In an example, the AIOT grant which is larger than a threshold may be used only for command transmission. In an example, the AIOT grant which is smaller than a threshold may only be used for the MSG1 reception.

The one or more factors may be associated with the frequency and/or a frequency range of the AIOT grant. In an example, the AIOT grant allocated on multiple frequency resources may be restricted for reception of the MSG1 and/or reception of the MSG3.

The one or more restrictions may be based on a time relationship between the one or more AIOT grants and/or between transmissions and/or receptions. The reader may determine the restriction based on the timing relationship between the one or more AIOT grants and/or the timing relationship between one or more transmissions performed in one or more previous AIOT grants.

The one or more factors may be associated with the timing of the AIOT grant, possibly relative to another AIOT grant, to the one or more messages transmitted in another AIOT grant, to network signalling, to a request by the WTRU for the one or more resources to the network, to the reception of an AIOT operation from the network, to the reception of a message from the AIOT device, etc. In an example, if two grants are separated by less than x slots and/or more than y slots, the first grant may be used for an occasion start transmission and/or the MSG1 reception, and the second grant may be used for the MSG2 transmission. In an example, the AIOT grant can only be used for the MSG2 transmission if the AIOT grant is located not more than x slots from a slot which was used for the MSG1 reception. In an example, the next resource (in time) after a resource that was used for the MSG1 reception may be used for the MSG2 transmission. In an example, the resource received immediately after reception of the message (e.g., the MSG3) from the AIOT device may only be used for command transmission to that AIOT device if that AIOT device has a pending command. In an example, the resource which occurs less than x slots from the transmission by the AIOT device cannot be used to transmit to that same AIOT device.

The reader may be configured and/or preconfigured with one or more restrictions for multiple transmissions and/or messages in the same AIOT grant. The reader may perform multiple AIOT transmissions in the same AIOT grant. This may include performing one or more distinct transmissions, and/or transmitting separate messages in the same resource, possibly where such transmissions are spaced by a finite period of time, or possibly where the second transmission is started immediately after the first transmission ends. In an example, the reader may receive a multi-slot AIOT grant and within that AIOT grant, may transmit a first command message followed by a second command message, possibly by leaving a finite period of time between the command message transmissions. In an example, the same solutions may be applicable for including multiple messages (e.g., one or more AIOT specific messages, one or more upper layer messages, and/or one or more AS layer control messages, etc.) in the same transmissions. In an example, a L2 and/or PHY layer transmission format and/or message format may allow for the transmission of multiple AIOT messages to the same or different AIOT devices. In an example, the reader may transmit the MSG2 (i.e., which includes at least an echo of the random ID received from the AIOT device performing random access) to multiple AIOT devices in a single transmission. In an example, the reader may include, in the transmission, multiple random IDs received over a recent time period and/or in a previous set of resources intended for the MSG1 transmissions. Each of the implementations herein may be applicable to either case of including multiple transmissions in the resource and/or including the multiple AIOT messages in the transmission, or both.

The reader may be configured with the one or more restrictions or the one or more rules related to which the one or more messages and/or transmissions may be included in the same AIOT grant. Such restrictions may be related to, for example, the number of messages. In an example, the reader may limit the number of messages included in the AIOT grant to a maximum of a configured value. In an example, the one or more restrictions may be related to the one or more intended devices. The reader may select a first device to transmit the message to in the AIOT grant. Subsequent to this, all other messages cannot be transmitted to the same AIOT device. The reader may select the first message which is intended to all the AIOT devices. Subsequent to this, all the other messages to be transmitted must be intended only to a single AIOT device. In an example, the restrictions may be related to the type of messages. The reader may select the first message to include in the AIOT grant, and may only allow transmission of a second message which is limited to a subset of messages defined related to the first message. The reader who transmits the MSG2 (including multiple random IDs) in the AIOT grant, may not be allowed to transmit other MSG2s (including a different set of random IDs) in the same AIOT grant. The reader who transmits the MSG2 in the AIOT grant may subsequently transmit only command messages in the same AIOT grant.

The reader WTRU may be provided the grant for AIOT transmissions. The reader may use selection rules herein and/or restriction rules defined above, potentially in any combination, to determine the final set of messages to be included in the grant. In addition to such grant, the reader WTRU may reserve all or a part of the grant provided by the network for transmissions by the one or more AIOT devices. In such a case, the reader WTRU may include, in its own transmission within the grant, the information to the AIOT device for the AIOT device to determine that the transmission is allowed by that AIOT device. The information may include the time and/or frequency of the part of the grant to be used for the transmission of the AIOT device. In an example, the reader may assume a worst-case time period for the transmission when reserving the one or more resources for the transmission of the AIOT device within the grant.

The reader may receive multiple AIOT resource grants from the network with conflicting time and/or frequency resource allocations. In an example, the reader WTRU may receive a semi-periodic AIOT resource grant for the inventory procedure for a first set of devices from the network via e.g., the RRC configuration, the MAC CE activation of a configured and/or preconfigured semi-persistent configuration. At another time, the reader WTRU may receive a second AIOT resource grant for the second set of AIOT devices. The second set of devices may be the same or different from the first set of AIOT devices or may include a third set of AIOT devices which is common between the first and second sets of AIOT devices. The indication for the second AIOT resource grant may be indicated in a similar manner as the first AIOT resource grant (e.g. the RRC and/or the MAC CE activation etc.), or indicated via a different mechanism, e.g. the DCI and/or a dynamic indication. In an example, the time and frequency resources from the first and second AIOT resource grant may overlap fully or partially. In an example, the AIOT resource grants may have different restrictions. The reader may prioritize the AIOT resource allocation configuration for the second resource grant over the first grant.

In an example, the prioritization may be made implicitly based on details of the indication. In an example, a dynamically indicated resource grant may always be prioritized over a periodic and/or a semi-statically configured resource grant. In another example, the resource grant restricted only for read and/or write commands may always be prioritized over a resource grant which allows e.g. the inventory procedures, etc.

In an example, the prioritization may be indicated explicitly to the reader WTRU from the connected gNB. In one method, the WTRU may be configured to prioritize the AIOT resource grants based on the resource grant identifier. In an example, one or more resource grant IDs from 1−M may be configured to have higher priority over N−M other resource grant IDs. In an example, the resource grant may include an explicit priority indicator (e.g. priority=0, . . . , P−1). The reader WTRU may use the explicit priority indication to determine which resource has precedent when conflicting with other resource grants of differing priority indication.

The MSG2 transmission may be impacted by one or more transmission characteristics associated with the received MSG1. In one or more examples, the MSG1 transmission characteristic may include one or more of the following: a received signal power of the MSG1, a number of repetitions of the random number or of the MSG1 (e.g., multiple PHY layer repetitions), a range of values from which the random number in the MSG1 is selected, a size (number of bits) of the MSG1, and/or a time and/or frequency resource selected for the MSG1 transmission. In an example, specific time and/or frequency resources may be set aside for re-access following a failed access by the device and such may require the reader to handle the MSG2 for these devices differently.

In an example, the duration (in time) of the MSG1 transmission may be determined based on whether the MSG1 includes data or not. In an example, namely, whether the AIOT device initiated a 2-step or 3-step random access.

One or more conditions may be defined with respect to the MSG1 transmission characteristic. For example, the one or more conditions regarding the received signal power (e.g., a signal power above or below a threshold and/or or within a range of thresholds etc.) may be used to determine the reader WTRU behavior herein.

The reader may determine whether to use the resource to transmit the MSG2. The reader may determine whether to use the resource for the MSG2 transmission. In an example, at the time of processing the grant, the reader may decide whether to use the grant for the MSG2 transmission. The reader which determines to use a grant for the MSG2 transmission may perform at least one or more MSG2 transmissions (i.e., include at least one or more random IDs, each including a random ID received previously in the MSG1 transmission by the AIOT device). The reader may further include other transmissions (e.g., command transmission) in the grant along with the MSG2 transmission.

The reader which determines not to use the grant for the MSG2 transmission may perform one or more of the following: use the grant for another message, allocate the grant to an AIOT device for the AIOT device transmission, not use the grant for AIOT, transmit an indication of non-usage (e.g., UTO-UCI-like) to the network, and/or transmit a request for additional resources to the network.

The reader may use one or a combination of more than one of the following to determine whether to use the resource to transmit the MSG2. In an example, two or more conditions from a subset of the conditions may need to be satisfied to use the resource to transmit the MSG2. In an example, at least one condition from a subset of the conditions may need to be satisfied to use the resource to transmit the MSG2. In an example, if a first condition is satisfied, a second condition (and/or a second set of second conditions) should be satisfied, otherwise a third condition (and/or a set of third conditions) should be satisfied. Similarly, the reader may use any or a combination of the conditions below to determine whether to prioritize transmission of the MSG2, possibly compared to another message.

In an example, the reader may use the resource grant for the MSG2 transmission if the reader has received the MSG1 from at least one AIOT device and has not responded. In an example, the reader may use the resource grant for the MSG2 transmission if it has at least one MSG1 pending. In an example, the MSG1 is pending if the reader has received the MSG1 from the AIOT device and has yet to respond using the MSG2 containing the same random ID. In an example, the MSG1 is pending if the reader has received the MSG1 from the AIOT device, the reader has yet to respond using the MSG2 containing the same random ID, and less than a configured period of time has elapsed since reception of the MSG1. In an example, the MSG1 is pending if the reader has received the MSG1 from the AIOT device, it has yet to respond using the MSG2 containing the same random ID, and at least one or all configured transmission conditions for the MSG1 are satisfied. In an example, the MSG1 is pending if the reader is unable to receive and/or decode the MSG3. In an example, the MSG1 is pending if the reader is unable to receive and/or decode the MSG3, and less than the configured period of time has elapsed since reception of the MSG1. In an example, the MSG1 is pending if the reader is unable to receive and/or decode the MSG3, and less than the configured period of time has elapsed since the MSG3 was expected by the reader

In an example, the reader may use the resource grant for the MSG2 transmission if one or more or all of the MSG1s received, if one or more or all of the MSG1s it will respond to in the MSG2, if one or more or all of the MSG1s it has yet to respond to: occurred at least a time period (e.g., x slots) prior to the occurrence of the resource, and/or, occurred at most a time period (e.g., y slots) prior to the occurrence of the resource.

In an example, the reader may use the resource grant for the MSG2 transmission if at least the configured and/or preconfigured or determined number of MSG1s are pending.

In an example, the reader may use the resource grant for the MSG2 transmission if some or all of the MSG1s received, some or all of the MSG1s it will respond to, some or all of the MSG1s it has yet to respond to are unique.

In an example, the reader may use the resource grant for the MSG2 transmission if some or all of the MSG1s received, some or all of the MSG1s it will respond to, some or all of the MSG1s it has yet to respond to fall within a specific range (e.g., where such range may be configured with the grant itself and/or preconfigured at the reader).

In an example, the reader may be configured with a minimum time (e.g., a number of slots, a number of AIOT occasions, etc.) between transmissions of the successive MSG2 transmissions. In an example, if the grant occurs at least X slots after the last transmission of the MSG2 by the reader, the reader may transmit the MSG2.

In an example, in addition to a random ID, the AIOT device may transmit an indication which impacts the reader's decision of whether to use the resource to transmit the MSG2. The indication may represent a priority. The indication may represent whether the access is a re-access (after failure) or an initial access. The indication may indicate the number of retries of the access by the device. Such indication may represent a limitation in the energy at the device. The indication may indicate whether the device may monitor over multiple occasions for the MSG2. In an example, the indication may contain the number of occasions the device will continue monitoring for. Based on the indication, the reader may use the resource for the MSG2 transmission or not, possibly in combination with another condition. In an example, if the indication represents high priority, the reader may use the resource for the MSG2 if the resource occurs at least X1 slots after the MSG1. Otherwise, the reader may use the resource for the MSG2 only if the resource occurs at least X2 slots after the MSG1. In an example, if the indication represents the device being able to monitor more than one occasion, the reader may use a resource only when it has received at least X (configured) distinct MSG1 transmissions. Otherwise, if the AIOT device indicates it cannot monitor multiple occasions, the reader may use the resource as long as occurs in the same occasion as the received MSG1 transmission. In an example, the indication may define the maximum time after the MSG1 transmission that the AIOT device will monitor for the MSG2 before declaring a failed access, and the reader may use this information to determine whether to use the current grant or next grant to perform the MSG2 transmission.

In an example, the reader may use the resource for the MSG2 transmission if the size of the resource is at least or at most a configured and/or preconfigured size. In an example, the reader may use the resource for the MSG2 transmission if the resource is large enough to include all the pending MSG1 transmissions. In an example, the reader may use the resource for the MSG2 transmission if the resource is large enough to include at least a configured and/or preconfigured number or percentage of pending the MSG1s. In an example, the reader may use the resource for the MSG2 transmission if the resource is large enough to include all the pending MSG1 transmissions which satisfy the one or more MSG1 transmission properties or conditions herein.

The reader may use the resource for the MSG2 transmission depending on the presence of a subsequent grant which is determined to also be usable (based on one or more conditions herein on use of the grant for the MSG2) for the MSG2 transmission

The reader may use the resource for the MSG2 transmission if it has the one or more grants available for the MSG3 transmission and can be used to transmit the MSG3 for all the AIOT devices indicated or to be indicated (by a random ID) in the MSG2. In an example, the reader may use the resources for the MSG2 transmission if it has one or more grants available that can be used to transmit the MSG3 for at least a configured number of AIOT devices (where the number of AIOT devices corresponds to the number of random IDs which will be transmitted by the reader. In an example, the reader may determine the resource as a usable for the MSG3 transmission by the AIOT device if it satisfies any of the conditions defined herein.

The one or more conditions may be associated with determining whether the MSG2 is triggered by a retransmission or not. In an example, the one or more conditions, criteria, thresholds, minimum and/or maximum values, etc, for determining whether to use the resource for the MSG2 transmission or not may differ for transmission of the MSG2 in response to the MSG1 compared to the MSG2 in response to a failed decoding of the MSG3.

The reader may determine the duration and/or amount of the resources required to transmit the MSG2. In an example, the reader may determine the size, amount, duration, and/or portion of the grant required for the MSG2 transmission based on one or more of a combination of the following: a network configuration a transmission characteristic, and/or a number of random IDs etc. In an example, the network may provide (e.g., in the grant, in a configuration parameter) an encoding rate, a number of repetitions, and/or a redundancy factor, etc, which may be used by the reader to determine the required resources to transmit the MSG2. In an example, the reader may determine the required resources based on any transmission characteristics associated with the MSG1 described herein. In an example, the reader may transmit a single PHY layer transmission containing multiple random IDs. The reader may transmit the MSG2 to multiple individual devices with the same transmission. The reader may determine the amount of resources required for transmitting the MSG2 based on the number of random IDs included in the message.

The reader may select a subset of the received MSG1 transmissions to respond to in the MSG2. In an example, the reader may determine to transmit the MSG2 in the resource and may determine the subset of the pending MSG1 transmissions to respond to in the MSG2. In an example, the reader may include a subset of the received random IDs from the MSG1 receptions into the MSG2 transmitted in an allocated resource.

The reader may decide to include the subset of the IDs (and/or the number of IDs) based on the amount of resources in the grant, and the amount of resources required to transmit the MSG2. In an example, the reader may decide to include a subset of the IDs (and/or the number of IDs) based on the amount of resources in the grant, the amount of resources required to transmit another message other than the MSG2 (which may be considered higher priority than the MSG2) and the amount of resources required to transmit the MSG2.

The reader may include the one or more random IDs into the MSG2, possibly if the reader cannot include all the random IDs from the pending MSG1 transmissions, using any of the following procedures, for example, the reader may include as many as can be included in the available resources of the grant. In an example, the reader may include only a threshold number into the grant. The remainder of the grant may remain unused. The remainder of the grant may be used for another AIOT message. The reader may include only those random IDs where the MSG1 reception meets a condition, where such condition can be any of the one or more conditions, for example, the reader may include the random IDs where the MSG1 reception meets the one or more condition, where one such condition may be for example, if the grant is large enough to include additional IDs, the WTRU may include additional IDs, based on selection of another condition, where such condition may be any condition described herein. The reader may include at least a threshold number into the grant. The remainder of the grant may remain unused. The remainder of the grant may be used for another AIOT message. The reader may include a threshold number into the grant. Following the use of the remainder for another message, if there is still space in the grant, the reader may add additional random IDs until the grant is fully utilized. The reader may use the grant first for another message. The reader may use the remainder of the grant for the MSG2 transmission, where as many random IDs are included that may be included into the remainder of the grant.

In an example, possibly if the reader is unable to include all the pending MSG1 random IDs in the grant for the MSG2 transmission, the reader may include the maximum number of random IDs which may be included in the grant. In an example, possibly if the reader is unable to include all the pending MSG1 random IDs in the grant for the MSG2 transmission, the reader may include the threshold number and/or a threshold percentage of the random IDs of the pending MSG1 transmissions, where such threshold may be configured by the network, related to the device types, related to the AIOT operation type, etc.

In an example, possibly if the reader is unable to include all the pending MSG1 random IDs in the grant for the MSG2 transmission, the reader may include only the random IDs in the MSG2 for which the MSG1 meets a transmission condition described herein. In an example, the grant may be configured and/or associated only with the transmission of the random IDs which are associated with the MSG1 having a specific transmission condition described herein.

The reader prioritizes the random ID for inclusion in the MSG2. The reader may apply the prioritization rule for selection of the random ID for inclusion in the MSG2. The prioritization rule may be used in any of the above examples. In an example, the prioritization rule may determine whether to include the random ID in the MSG2 or not, possibly in the case the grant is not large enough to fit all random IDs of the pending MSG1 transmissions. In an example, the prioritization rule may be used to determine an order in which to include the random ID into the MSG2. In an example, the prioritization rule may be used to determine which additional random IDs to include in the MSG2 when the required IDs have been included. In an example, the prioritization rule may be used to determine whether to use the grant for the MSG2 transmission, based on whether the grant can include all of the random IDs where the prioritization rule is met.

The prioritization rule may be based on the transmission property of the MSG1. In an example, such rule may be any or a combination (e.g., and, or, etc.) of the following, for example, a rule based on the received power of the MSG1 transmission. In an example, include only the random IDs where the corresponding MSG1 transmission was received above the threshold. In an example, the reader may include the random IDs in the order of received power of the MSG1 transmission. The rule based on the number of retransmissions and/or repetitions of the random ID in the MSG1 and/or of the MSG1 itself. In an example, the reader may include only the random IDs where the received the MSG1 had at least X repetitions. In an example, the reader may include the random IDs in the MSG2 in the order of decreasing number of repetitions. In an example, the reader may include random IDs in MSG2 with the largest number of repetitions first, and if there is still available space in the grant, include as many random IDs as there is space in the grant in order of decreasing number of repetitions.

The rule may be based on the value of the random ID itself. In an example, a specific grant may be associated only with the random IDs in a predefined range. The reader may include only the random IDs in the MSG2 with the pending MSG1 where the random ID fall within the range.

The rule may be based on the size (e.g., the number of bits) of the MSG1. In an example, a specific grant may be associated only with the random IDs of the specific number of bits.

The rule may be based on the time and/or frequency resource selected for the MSG1 transmission. In an example, the specific grant may be associated only with the random IDs received in the MSG1 that were transmitted by the devices in a frequency range and/or resource block.

The rule may be based on the duration (e.g., in time) of the MSG1 transmission. In an example, when including the random IDs in the MSG2, the reader may include them in the order of decreasing duration of the corresponding MSG1 transmission.

The rule may be based on the time since the random ID was received in the MSG1 (e.g., relative to the timing of the grant to be used for the MSG2). In an example, the resource may be used for the MSG2 transmission if it is large enough to include all the random IDs from the MSG1 transmissions which were received in the current access occasion (or in the last X access occasions), where X can be configured by the network. In an example, the reader may include all the random IDs from the MSG1 transmission which were received at least X and/or at most Y slots prior to the grant for the MSG2. In an example, the reader may include random IDs in the MSG2 in the order of the time prior to the grant in which the MSG1 was received (largest time first). In an example, the reader may include the random IDs in the MSG2 from the MSG1s received in previous access occasions. Only if there is space in the grant, the reader may include also random IDs in the MSG2 from the MSG1s received in the current access occasion.

The rule may be based on the presence of one or more paging messages, sync messages and/or other R2D messages occurring between the time the random ID was receive in the MSG1 and the timing of the grant to be used for the MSG2. In an example, the reader may include all the random IDs from the MSG1 transmissions whereby at least X R2D transmissions of sync and/or paging messages occur between the MSG1 transmission and the grant for the MSG2 transmission

The rule may be based on the presence of information transmitted along with the MSG1 (as described herein). In an example, the reader may first include all the random IDs from the MSG1 transmissions that contain an indication before including the other random IDs

The rule may be based on whether the MSG2 transmission is being performed due to failure to receive the MSG3. In an example, the reader may decide to use the grant for transmission of the MSG2 to trigger the MSG3 retransmission (as a result of the reader failing to receive the MSG3). Specifically, following the previous transmission of the MSG2 to one or more AIOT devices, the reader may allocate resources for the MSG3 transmission by those AIOT devices. If the reader is unable to decode the MSG3 from any of those AIOT devices, the reader may retransmit the random IDs associated with the failed MSG3. The reader may include, in the MSG2, the random IDs of the failed MSG3 transmissions. In an example, the reader may include, in the MSG2, first the random IDs of the failed MSG3 transmissions. If there is additional space in the grant, the reader may include the random IDs associated with the received MSG1 transmissions. In an example, the reader may use the grant only for transmission of the X failed MSG3 transmission, where X may be configured and/or specified. In an example, if the grant is available for transmission of the MSG2, the reader WTRU may first use that grant for transmission of the MSG2 associated with the one or more failed MSG3 transmissions, and may use subsequent grants for the other MSG2 transmissions.

The rule may be based on the random-access types (e.g., 2-step vs 3-step). In an example, the reader may decide to use the grant for transmission of the random IDs associated with only one of the two types. In an example, if the grant is used for transmission of the random IDs associated with 2-step (e.g., 3-step) random access, only the random IDs associated with transmissions of the MSG1 associated with 2-step (e.g., 3-step) random access may be included in the MSG2.

The reader may trigger re-access for AIOT devices in which the MSG2 is not transmitted. The reader may trigger the re-access for one or more devices having the pending MSG1 transmission or for which the MSG3 was not received correctly. In one example, the re-access may be triggered by an explicit message (e.g., the control message) transmitted by the reader (e.g., in an R2D sync message). In an example, the control message may contain a bitmap of the MSG1 resources, and a bit set in the associated location in the bitmap may indicate to the AIOT device that transmitted the MSG1 to perform the re-access. In an example, an R2D message (e.g., an access start message) may contain an indication which is sent to trigger all (or an indicated subset, e.g., based on an indication of the resource index within that access occasion) devices which transmitted the MSG1 in the previous access occasion to initiate the re-access. In an example, the re-access may be triggered implicitly by the absence of the MSG2 transmission by the reader.

The AIOT device may initiate re-access if, for example, the AIOT device does not receive MSG2 (i.e., its random ID) within a configured and/or preconfigured time period following transmission of the MSG1. The AIOT may receive an occasion start message (i.e., an R2D message indicating the start of an access occasion) before receiving the MSG2 (containing its random ID). The AIOT device receives X occasion start messages before receiving the MSG2 (containing its random ID). The AIOT device may receive a paging message before receiving the MSG2. The AIOT device may receive X paging messages before receiving the MSG2. The AIOT device may receive an occasion start message and/or a paging message with an occasion number indicating at least X occasions have passed since the transmission of the MSG1 (e.g., the occasion number indicated in the R2D message, e.g., the occasion number where the AIOT device transmitted message 1>X).

The reader may receive the MSG1 from the device, but may trigger re-access for that AIOT device due to a lack of resources (e.g. unavailability of a grant) for transmission of the MSG2. In an example, the re-access may be triggered if the MSG2 is not transmitted. In an example, the re-access may be triggered if the random ID is not included in the MSG2 as the result of the selection criteria herein. In an example, the re-access may be triggered if the resource which may be used for the MSG2 transmission is not identified before the occurrence of the resource which is dedicated for occasion start transmission. In an example, the re-access may be triggered if the only resource allocated for MSG2 transmission is not large enough to include a specific random ID, based on the ID selection rules herein. In an example, the re-access may be triggered if the resource which may be used to transmit the MSG2, or which may be used to include the random ID for which the MSG1 is pending does not occur for the configured period following the reception of the MSG1. In an example, the re-access may be triggered if the resource which can be used to transmit the MSG2, or which can be used to include the random ID for which the MSG1 is pending does not occur for a number of configured access period (access period starts) following the reception of the MSG1, where such configured access period starts may be 1.

The resource for the MSG2 may not be determined by the reader, for example, due to the reader prioritizing grants for other uses (e.g., transmission of command) as described herein, for example, the reader may select resources to be reserved (allocated to device) for the MSG3 transmission.

The reader may select resources among the one or more grants from the network for allocation of the MSG3 transmission. The reader may determine the amount of resources for the MSG3 transmission using similar rules as the MSG2 resource selection. The reader may divide the resources for the MSG3 transmission into a number of sub-resources, where each sub-resource corresponds to the resource for transmission of the MSG3 by one device. The sub-resources may be a specific time and/or frequency resource. The sub-resources may last for a maximum period of time. The sub-resources may be contained within the grant allocated by the network. The required size and/or number of resources (e.g., number of slots) for the sub-resources may be determined using the one or more factors similar to the determination of the resource size for the MSG2.

In a first approach, the reader may determine the number of the MSG3 sub-resources (and/or the required MSG3 sub-resources) based on the number of random IDs included in the MSG2, based on decision criteria for selecting the random IDs defined herein.

In a second approach, the reader may select the number of sub-resources based on the sub-resource feasibility criteria and a required sub-resource size, and may determine the number of random IDs to include in the MSG2 based on the determined number of sub-resources.

In the second approach, the reader may determine the feasibility of the sub-resource based on one or more or a combination of the following, for example, the time difference between the determined and/or selected resource for the MSG2 transmission, and the potential sub-resource for the MSG3 transmission. In an example, a potential sub-resource may be the sub-resource for the MSG3 transmission if it occurs at least X slots and/or at most y slots from the timing of the MSG2 resource.

The reader may determine the frequency (and/or the resource block) where the sub-resource is located. In an example, the potential sub-resource may be the sub-resource for the MSG3 transmission if the frequency matches one of the frequencies in which the MSG1 was transmitted for one of the pending MSG1 transmissions. In an example, the potential sub-resource may be a sub-resource if it is located at most a frequency distance of X from the frequency location of the MSG2 resource.

The reader may determine whether the potential sub-resource is located in the same grant as another potential sub-resource or of the resource to be used for the MSG2. In an example, the potential sub-resource may be the sub-resource if it is located in the same resource grant (from the network) as the MSG2 resource.

The reader may determine the size of the potential sub-resource. In an example, the potential sub-resource may be a sub-resource if it is at least a specific size (e.g., in terms of time frequency resources) and/or if it can accommodate at least a specified or configured number of bits. Such number of bits may further be determined using the one or more factors similar to those defined herein for the MSG2 size determination. In an example, the potential sub-resource may be the sub-resource if it is sufficiently large to transmit the MSG3 for a specific AIOT device, considering the determined size of the MSG3 resource as per herein

In command transmission, the reader may determine whether to use the resource to transmit the command. The reader may determine to use the grant for transmission of the command, and potentially for allocation of the command response by the AIOT device. The reader may obtain (e.g., from the network) the expected size of the command response, and may use that information in determining whether to use the grant for command transmission. The reader may perform such determination based on one or more of the following, for example, the pending MSG1. In an example, the reader may use the resource grant for command transmission if there are no pending MSG1.

The reader may determine a time between the pending MSG1 and the corresponding resource. In an example, the reader may use the resource grant for the command transmission if there are no pending MSG1 for which the time between the resource and the MSG1 is larger than X and/or smaller than Y.

The reader may determine the number of the pending MSG1. In an example, the reader may use the resource grant for command transmission if the number of the pending MSG1 is less than a threshold.

The reader may determine a number of occasions and/or time since the last transmission of the MSG2. In an example, the reader may use the resource for command transmission as long as the time since the last transmission of the MSG2 is less than a threshold

The reader may determine one or more indications in the received MSG1. In an example, based on the indication in one or more MSG1 which may be pending, the reader may determine whether to use the resource for command transmission or not, possibly in combination with another condition. In an example, if the indication represents high priority, the reader may use the resource for the MSG2 rather than the command if the resource occurs at least X1 slots after the MSG1. Otherwise, the reader may use the resource for the MSG2 only if the resource occurs at least X2 slots after the MSG1. Otherwise, the reader may use the resource for command transmission. In an example, if the indication represents the device being able to monitor more than one occasion, the reader may use the resource for command transmission. Otherwise, if the device indicates it cannot monitor multiple occasions, the reader may use the resource for the MSG2 transmission rather than the command transmission. In an example, the indication may define the maximum time after the MSG1 transmission that the AIOT device will monitor for the MSG2 before declaring a failed access, and the reader may use this information to determine whether to use the current grant for the MSG2 transmission and/or the command transmission.

The reader may determine a size of the resource. In an example, the reader may use the resource for the command transmission if the resource is large enough for the command transmission and to allocate the resources for the response.

The reader may determine the presence of another grant. In an example, the reader may use the resource for command transmission depending on the presence of a subsequent grant which is determined to also be usable (e.g., based on conditions herein on use of the grant for command) for the command transmission.

The reader may determine the availability of the resources for the MSG3. In an example, the reader may use the resource for the command transmission if it does not have any grants available for the MSG3 transmission that can be used if the MSG2 is transmitted in the grant (instead of the command).

The reader may determine a time between the reception of the MSG3 from the device and the corresponding resource. In an example, the reader may use the resource for command transmission to the AIOT device if the resource is located at least X and/or at most Y slots from the reception of the MSG3. In an example, the reader may use the resource for command transmission to the AIOT device as long as the resource is located at least X access occasions and/or at most Y access occasions from the time the MSG3 was transmitted by the AIOT device. In an example, if the time since MSG3 transmission is smaller than a threshold, the reader may only use the resource for the command if the command and response can fit in the resource. Otherwise, the WTRU may use the resource if the command itself (without necessarily the entire response) can fit in the resource.

In an embodiment, the WTRU may receive the grant from the network for the AIOT transmission and/or operation. The WTRU may first determine which message and/or messages (e.g., the occasion start message, the MSG2, and/or the command) to transmit in the grant.

The determination rules may be based on the current stage of the AIOT inventory and/or command operation (e.g., whether the WTRU has received the MSG1, whether the WTRU has the pending MSG1, whether the WTRU has responded to any pending MSG1s already, etc.). In an example, if the command is pending and the MSG2 is not pending, the resource may always be used for command transmission as long as the command may be fit in the resource, otherwise, the WTRU may determine whether to use the resource for the command or the MSG2 first based on specific rules related to the priority of each.

In an example, prioritization between the command and the MSG2 may be determined. One transmission (e.g. the MSG2 versus the command) may be prioritized based on any of the rules described herein to use a grant for that message. After the prioritization is determined, the WTRU may, for example, use that resource only for the prioritized message. In an example, the WTRU may use that resource for the prioritized message, and if there is still space in the grant and the other message can be transmitted, use that resource for the other message as well. In an example, the WTRU may use that resource for the prioritized message, and if it is used for the other message as well, limit the contents of the other message using methods herein (e.g., limited number of the random IDs, transmit the command even if the response cannot all fit in the resource, etc.)

In an embodiment, the reader may receive a dynamic grant (e.g., in the DCI) which may provide a resource for AIOT transmission. The reader may have the pending MSG1 transmissions as well as the pending command transmissions at the time of reception of the grant.

In an example, the reader may first determine whether to prioritize transmission of the command or the MSG2. If there are at least X pending MSG1 transmissions for which the time since the reception of the MSG1 is larger than the threshold, the reader may prioritize the MSG2 transmission, otherwise, the reader may prioritize the command transmission. If the MSG2 transmission is prioritized, the reader may transmit the first MSG2 in the resource and then command transmission, otherwise, the reader may perform the transmissions in the opposite order. If the resource is large enough to transmit all random IDs of all the pending MSG1 and all received command transmissions, the reader may transmit the MSG2 containing all the random IDs, and may transmit all the commands.

If the resource is not large enough, the reader WTRU may perform one of the following options, for example, the reader may include only the random IDs for the MSG2 for which the MSG1 meets the transmission criteria described herein. The WTRU may then include the one or more command messages, whereby the WTRU may select the command based on the AIOT device (that is the target of the command) where the MSG3 was transmitted the first of the AIOT devices with the pending command and include the commands in that order, until all commands are included and/or there is no more space available in the grant.

In an example, the reader may include only the random IDs for the MSG2 for which the MSG1 meets the transmission criteria described herein, for example, the WTRU may then include as many command messages for which the time since the MSG3 was transmitted for the AIOT device to which the command is intended is above the threshold. If there is remaining space in the grant, the WTRU may include additional random IDs in the MSG2.

In an example, if the resource grant does not contain resources sufficient for the MSG3 transmission of at least X devices, the reader may prioritize the command transmission. In such case, the reader may use the resource only for the command transmission.

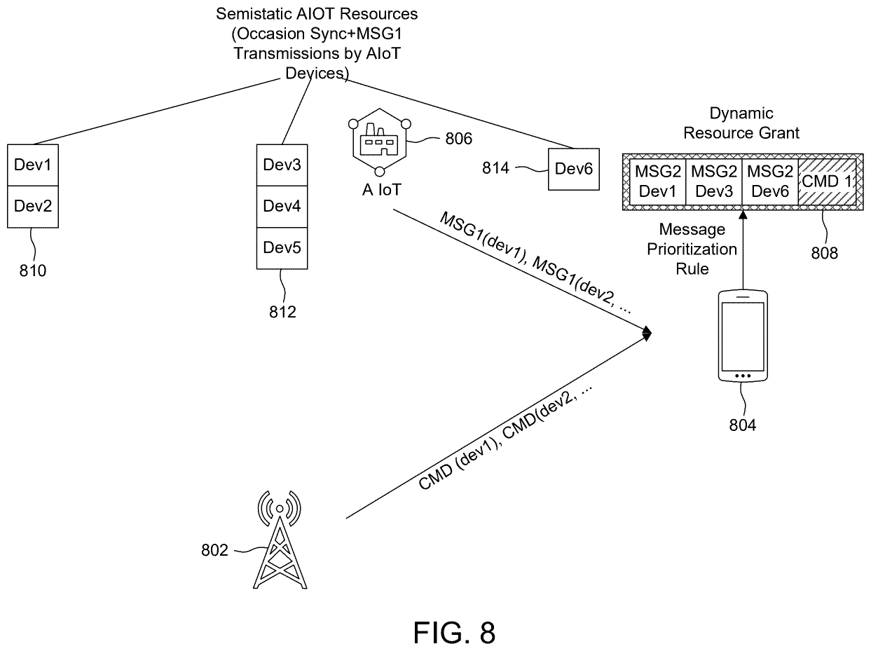

Referring now to FIG. 8, an example message transmission procedure is illustrated according to one or more embodiments. FIG. 8 shows a base station 802, a reader WTRU 804, and an IOT 806. FIG. 8 shows a general procedure of the prioritization between the MSG2 transmission and the command transmission. The reader WTRU 804 receives the MSG1 transmission during the inventory procedure for multiple AIOT devices. The MSG1 transmissions may include a random ID, indicated in the figure as dev1 and dev2 etc. The transmissions for these random IDs may be performed in the set of semi-static resources allocated by the network (e.g., the base station 802) to the reader WTRU 804, and which the reader WTRU 804 transmits to the AIOT devices in the paging message and/or the occasion start message. Additionally, during the inventory procedure, the reader WTRU 804 may receive multiple command messages for a potentially different set of devices. Such command messages may be received once a device has successfully transmitted the MSG3 to the reader WTRU 804, and that the reader WTRU 804 has forwarded the contents of MSG3 to the network (e.g., the base station 802).

At some stage of the inventory procedure, the reader WTRU 804 may receive the dynamic grant which can be used to transmit the MSG2 and/or command. The WTRU may apply a prioritization rule when determining which transmissions to perform (and how to use the resources between each of the messages) for the AIOT operation.

In the exemplary embodiment, the WTRU first determines if the grant is large enough to be used for the MSG2 and the command. In such determination, the WTRU may determine that there are sufficient resources for the MSG2 transmission containing each of the random IDs, and that the grant also has sufficient resources for the one or more sub-resource to be assigned for the MSG3 transmission from each of the devices to which the MSG2 will respond to. The one or more sub-resources may be obtained from a different grant and/or may be part of the dynamic grant itself. If the grant is large enough to include all of the random IDs from the pending MSG1 and the command, the WTRU may include all of the random IDs. Otherwise, the WTRU may include only the random IDs associated with the pending MSG1 which were received with a specific transmission condition met (e.g., the RSRP of the MSG1 above the threshold). Following such, if there is additional space in the grant, the reader WTRU 804 may include the command message transmission in the grant. Following such, if there is additional space in the grant, the reader WTRU 804 may include further random IDs, whereby the random IDs included first are the ones for which the time difference between the MSG1 transmission and the grant is the largest.

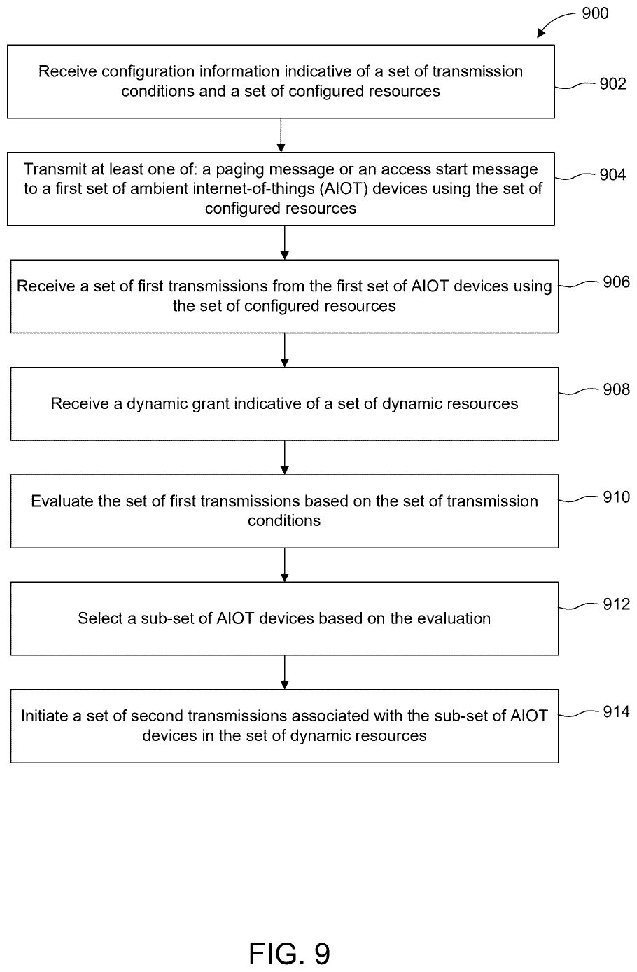

FIG. 9 is a flowchart illustrating a method 900 for AIOT grant processing according to one or more embodiments. The method 900 may be performed by the reader WTRU. In the method 900, the reader WTRU determines the number of MSG2 and/or command transmissions and the corresponding recipient AIOT devices of those transmissions to include in the network provided AIOT resource grant based on the grant size, the one or more MSG1 transmission properties and the timing of the MSG1 reception compared to the grant.

At 902, the reader WTRU receives, from the base station, the configuration information indicative of the set of transmission conditions and the set of configured resources. The reader WTRU receives (e.g., in the RRC signaling) the one or more configured first transmission (e.g., the MSG1) property conditions (i.e., the set of transmission conditions). In an example, the set of transmission conditions may include the threshold first-transmission received signal strength (e.g., the RSRP of the MSG1). In an example, the set of transmission conditions may include the threshold number of first-transmission retransmissions by one or more AIOT devices. In an example, set of transmission conditions may include one or more conditions to prioritize a re-access.

At 904, the reader WTRU transmits at least one of: the paging message or the access start message to the first set of AIOT devices using the set of configured resources. The reader WTRU receives (e.g., in the RRC signaling) the set of semi-static resources (e.g., the CGs) for initiation of the inventory and/or command procedures. The reader WTRU transmits, in the semi-static resources, the AIOT paging message and/or the one or more access occasion start messages.

At 906, the reader WTRU receives a set of first transmissions from the first set of AIOT devices using the set of configured resources. The reader WTRU receives, in the set of semi-static resources, the one or more first transmissions from the first set of one or more AIOT devices performing the AIOT random access.

At 908, the reader WTRU receives, from the base station, the dynamic grant indicative of the set of dynamic resources. The reader WTRU receives (e.g., in the DCI) the AIOT-link grant (e.g. during the inventory operation). In an example, the AIOT-link grant can be e.g., multiple consecutive Uu slots and/or RBs usable for the AIOT transmission by the WTRU and/or devices.

At 910, the reader WTRU evaluates the set of first transmissions based on the set of transmission conditions. At 912, the reader WTRU selects the sub-set of AIOT devices based on the evaluation. At 914, the reader WTRU initiates the set of second transmissions associated with the sub-set of AIOT devices in the set of dynamic resources.

The reader WTRU receives, from the network (e.g., in the RRC signaling), the one or more AIOT command messages (i.e., the upper layer data) to be transmitted to the second set of one or more AIOT devices, along with a required amount of AIOT resources to be used for the AIOT command response transmissions by the AIOT devices of the second set of AIOT devices. In an example, the second set of devices may be the same as the first set of devices.

If the grant is large enough to include all the second transmissions (i.e., the MSG2) to all the AIOT devices in the first set of AIOT devices (and corresponding third transmissions (e.g., the MSG3) by each AIOT device in the first set of AIOT devices) and the AIOT command transmissions to the AIOT devices in the second set of AIOT devices, the reader WTRU may include, in the grant, the second transmission for each AIOT device in the first set of AIOT devices, resources for the transmission of the third transmission by each of the AIOT devices in the first set of AIOT devices, one or more received AIOT command messages, and resources for the AIOT command response by the AIOT devices of the second set of AIOT devices.

If the grant is not large enough to include all the second transmissions (i.e., the MSG2) to all the AIOT devices in the first set of AIOT devices (and corresponding third transmissions (e.g., the MSG3) by each AIOT device in the first set of AIOT devices) and the AIOT command transmissions to the AIOT devices in the second set of AIOT devices, the reader WTRU may include, in the grant, only the second transmissions to the third set of AIOT devices (where the third set of AIOT devices is the subset of the first set of AIOT devices) for which the first transmission property condition is met, for example, when the first-transmission RSRP is above the signal strength threshold. In an example, the reader WTRU may include all re-access responses to the AIOT devices for which the re-access condition is met.

The reader WTRU may include, in the grant, the AIOT command messages to the fourth set of AIOT devices (where the fourth set of AIOT devices is a subset of the second set of AIOT devices). In an example, where the fourth set of AIOT devices is determined such that there are sufficient resources in the grant for the AIOT command message transmission and the command response for all the AIOT devices in the fourth set of AIOT devices.

If reader WTRU determines if there are one or more available resources in the grant. If the reader WTRU determines the one or more available resources, the reader WTRU may include any additional second transmissions and/or command transmissions based on the timing of the first transmission reception associated with the AIOT devices (i.e., for the AIOT devices not in the third or fourth set of AIOT devices) (e.g., select the second transmission and/or the command transmission with the largest time since reception, by the reader WTRU, of the first transmission from the AIOT device).

The reader WTRU may transmit the one or more messages (e.g., the second transmission and/or the command etc.) on the grant.

In operation, the reader WTRU may be configured and/or preconfigured with the one or more restrictions (e.g., the transmission conditions) for transmission on the grant. The reader WTRU may be configured and/or preconfigured with the one or more restrictions (e.g., one or more multiplexing conditions) for multiple transmissions and/or messages in the same grant. The MSG2 transmission may be impacted by the transmission characteristic associated with the corresponding received MSG1. The reader WTRU may determine whether to use the resource to transmit the MSG2. The reader WTRU may select the subset of received MSG1 transmissions to respond to in the MSG2. The reader WTRU may trigger the re-access for the one or more AIOT devices in which the MSG2 is not transmitted. The reader WTRU may select the one or more resources to be reserved (e.g., allocated to the AIOT device) for the MSG3 transmission. The reader may determine whether to use the one or more resource to transmit the one or more AIOT commands.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A wireless transmit/receive unit (WTRU), comprising:
a memory;
a transceiver; and
a processor, wherein the transceiver and the processor are configured to:
receive, from a base station, configuration information indicative of a set of transmission conditions and a set of configured resources,
transmit at least one of: a paging message or an access start message to a first set of ambient internet-of-things (AIOT) devices using the set of configured resources,
receive a set of first transmissions from the first set of AIOT devices using the set of configured resources,
receive, from the base station, a dynamic grant indicative of a set of dynamic resources,
evaluate the set of first transmissions based on the set of transmission conditions,
select a sub-set of AIOT devices based on the evaluation, and
initiate a set of second transmissions associated with the sub-set of AIOT devices in the set of dynamic resources.

2. The WTRU of claim 1, wherein evaluating the set of first transmissions includes determining that the set of dynamic resources is less than a required set of resources associated with the first set of AIOT devices.

3. The WTRU of claim 1, wherein the transceiver and the processor are configured to:
receive, from the base station, an indication of a set of AIOT resources and a set of AIOT commands associated with a second set of AIOT devices from the first set of AIOT devices, and
transmit the one or more AIOT commands from the set of AIOT commands to the second set of AIOT devices using one or more AIOT resources from the set of AIOT resources.

4. The WTRU of claim 1, wherein the transceiver and the processor are configured to:
determine one or more available dynamic resources from the set of dynamic resources after initiating the set of second transmissions,
determine that the one or more available dynamic resources are greater than a required set of resources associated with a third set of AIOT devices from the first set of AIOT devices, and
initiate the set of second transmissions associated with the third set of AIOT devices using the one or more available dynamic resources.

5. The WTRU of claim 1, wherein the set of transmission conditions includes one or more of:
a signal strength threshold, or
a retransmission threshold.

6. The WTRU of claim 5, wherein evaluating the set of first transmissions includes:
determining a received signal strength of a sub-set of transmissions of the first set of transmissions associated with the sub-set of AIOT devices.

7. The WTRU of claim 6, wherein selecting the sub-set of AIOT devices includes:
selecting the sub-set of AIOT devices upon determining that the received signal strength exceeds the signal strength threshold.

8. The WTRU of claim 5, wherein evaluating the set of first transmissions includes:
determining a number of retransmissions associated with the sub-set of AIOT devices.

9. The WTRU of claim 8, wherein selecting the sub-set of AIOT devices includes:
selecting the sub-set of AIOT devices upon determining that the number of retransmissions is less than the retransmission threshold.

10. The WTRU of claim 3, wherein the set of second transmissions includes at least one AIOT command of the set of AIOT commands.

11. The WTRU of claim 3, wherein the set of first transmissions includes at least one first message and the set of second transmissions includes at least one second message.

12. A method for use in a wireless transmit/receive unit (WTRU), the method comprising:
receiving, from a base station, configuration information indicative of a set of transmission conditions and a set of configured resources;
transmitting at least one of: a paging message or an access start message to a first set of ambient internet-of-things (AIOT) devices using the set of configured resources;
receiving a set of first transmissions from the first set of AIOT devices using the set of configured resources;
receiving, from the base station, a dynamic grant indicative of a set of dynamic resources;
evaluating the set of first transmissions based on the set of transmission conditions;
selecting a sub-set of AIOT devices based on the evaluation; and
initiating a set of second transmissions associated with the sub-set of AIOT devices in the set of dynamic resources.

13. The method of claim 12, wherein evaluating the set of first transmissions includes determining that the set of dynamic resources is less than a required set of resources associated with the first set of AIOT devices.

14. The method of claim 12, the method further comprising:
receiving, from the base station, an indication of a set of AIOT resources and a set of AIOT commands associated with a second set of AIOT devices from the first set of AIOT devices; and
transmitting the one or more AIOT commands from the set of AIOT commands to the second set of AIOT devices using one or more AIOT resources from the set of AIOT resources.

15. The method of claim 12, the method further comprising:
determining one or more available dynamic resources from the set of dynamic resources after initiating the set of second transmissions,
determining that the one or more available dynamic resources are greater than a required set of resources associated with a third set of AIOT devices from the first set of AIOT devices, and
initiating the set of second transmissions associated with the third set of AIOT devices using the one or more available dynamic resources.

16. The method of claim 12, wherein the set of transmission conditions includes one or more of:
a signal strength threshold, or
a retransmission threshold.

17. The method of claim 16, wherein evaluating the set of first transmissions includes:
determining a received signal strength of a sub-set of transmissions of the first set of transmissions associated with the sub-set of AIOT devices.

18. The method of claim 17, wherein selecting the sub-set of AIOT devices includes:
selecting the sub-set of AIOT devices upon determining that the received signal strength exceeds the signal strength threshold.

19. The method of claim 16, wherein evaluating the set of first transmissions includes:
determining a number of retransmissions associated with the sub-set of AIOT devices.

20. The method of claim 19, wherein selecting the sub-set of AIOT devices includes:
selecting the sub-set of AIOT devices upon determining that the number of retransmissions is less than the retransmission threshold.
